(19) United States
(12) Patent Application Publication
(10) Pub. No.: US 2018/0202414 A1
(43) Pub. Date: Jul. 19, 2018

(54) DYNAMIC WAVE POWER ENERGY CONVERTER

(71) Applicant: Alister Cumming Hume, Powell River (CA)

(72) Inventor: Alister Cumming Hume, Powell River (CA)

(21) Appl. No.: 15/407,227

(22) Filed: Jan. 16, 2017

(51) Int. Cl. F03B 13/22; F03B 13/14

(52) U.S. Cl. CPC F03B 13/22; F03B 13/145

(57) ABSTRACT

A device and methods for capturing and converting ocean waves forward motion and other suitable wave forms which could have velocities similar to ocean waves and be suitable for efficient conversion into electrical power. The device comprises a receiving platform and wave capture ramp to direct active waves up the ramp and onto an elongated large cylindrical apparatus with perimeter receiving buckets to capture the waves water flow and thereby rotate the large elongated water wheel capture apparatus. Said apparatus absorbs both the kinetic energy as well as receiving and exploiting the potential energy component of the wave transfer to the multiple capture buckets to rotate the water wheel apparatus as a function of the volumetric filling and emptying of same as the apparatus rotates. Unidirectional rotary motion of the apparatus is converted by a pressurized fluid output system coupled with the apparatus journal support assemblies, thereby charging accumulators which are subsequently drawn-down or discharged on a managed basis to power electrical generators. Load leveling system is provided and defined herein. The overall system encompasses a floating and transportable platform to house all of the ancillaries associated with the conversion process and suitable for cable transmission to a land based electrical grid. In non ocean wave applications, the same basic apparatus and technology could be employed using various types of receiving ramps and weir or flume type feed systems.

### FIELD OF THE INVENTION

The present invention relates to an apparatus and method for capturing the energy from any form of wave action. Typically this apparatus is designed for applications in the most rugged sea conditions on a world scale. More specifically, this apparatus is designed for sustained continuous operation and deployment in any of our world oceans, and within the full range of wave energy levels experienced at these highly variable well defined locations. Preliminary design, sizing and calculation of projected electrical conversion capacity for our commercial systems, indicate expected transmission loads of 75 to 100 megawatt hours per day (at an assumed nominal efficiency of 50 percent for the overall system installed capability) to any established and suitable receiving grid anywhere in the world. However, similar apparatus could be deployed, in modified form for other applications where high volumes of moving water at variable and intermittent flow conditions may be available for harvest under less severe environmental conditions. In non ocean applications, our unique invention would be designed for fit-for-purpose to accommodate a wide range of applications, be it the soul source of kinetic energy to drive pumps, etc, directly via appropriate transmission connections for a variety of remote process requirements. This invention pertains to a novel method to capture energy from ocean waves or other suitable flowing water sources and therein convert to electric power. More particularly this invention relates to an apparatus which encompasses a floating and transportable platform with all of the features and methods necessary to convert wave energy to electrical power in any suitable location on a world wide basis.

### BACKGROUND OF THE INVENTION

A myriad of tidal related and wave capture systems, devices, have been invented particularly in the last ten years, some of which have been developed and are in various stages of application, testing and further refinements. Major work continues in this field and is underway on a continuous basis, with numerous prototype apparatus being deployed in live ocean test beds around the world. These systems are the forerunners with respect to gathering and cataloging test data for further refinement in this wide open field of wave energy capture. Much research work has been undertaken and completed, particularly in the past few years, however there are still major hurdles to be tackled and overcome in reaching practical, environmentally friendly, cost competitive solutions to the massive energy forces available from our oceans around the world. Prototypes now being deployed in a variety of locations around the world, reflect quite conclusively that size of apparatus and sagacious designs will play a major roll with respect to survivability, as well as providing the necessary significantly higher electrical conversion figures per unit site to ensure these systems are competitive with other renewables.

The priority by all present parties in this wide open field is to continue refinements to find the most economical means to commercialize their concepts and practices for practical Wave Energy Converters, and at the same time be cost competitive with other forms of green energy, such as solar, wind and others.

The objective of this invention, is to develop, test under demanding atmospheric and tidal generated wave conditions, the practicality and cost effectiveness of our proposed wave capture apparatus. Capturing ocean wave energy and operating continuously in the very harsh ocean wave environment is a major challenge for all systems now in operation and/or apparatus in development or prototype stages.

There are numerous systems in development stages and some in prototype configurations that employ the concept of capturing the undulating movement of the wave and tidal action to move buoys, paddles and floats, either free floating or anchored in some manner in strategic locations. In these cases, the movement of the floating devices is used to activate or interact with paddles, and other mechanisms to create forces that may be used to activate cylinders, pulleys, vertical shafts, air chambers, etc., as a means of converting tidal movements into useful electrical energy.

There are a number of ramp-type overtopping wave apparatus currently being developed and/or in prototype stages, however, all employ capture of the ocean waves into fixed raised reservoirs, from which the water level accumulated is then drawn-down on a managed basis to feed specific types of low-head turbines to generate electrical energy on fixed speed generators. The “Wave Dragon” is perhaps the most advanced in utilization of overtopping into capture reservoirs and controlled draw-down, feeding low head generating converters. These systems are, out of necessity, very large indeed, in physical size as well as electrical conversion capabilities and at very high initial unit cost.

The applicants herein of this unique overtopping invention, have not been able to uncover, in our prior art search, any overtopping or related apparatus whereby the water directed up an inclining ramp is used directly to provide mechanical rotational motion to a receiving apparatus, the rotary terminator in our case. Our invention does not employ a fixed reservoir, which is then drawn-down to generate power from the potential energy held in a reservoir(s).

### SUMMARY OF INVENTION

The present invention relates to a rotatable apparatus or multiple apparatus which can be secured in position(s) whereby dynamic wave action is intercepted via a ramp device, and the waves thereon are raised to a higher level than nominal water level. The surging water mass is discharged from the overtopping ramp via a receiving weir (or flume) integrated into the ramp and thereby discharged into catchment buckets (flights) on the perimeter of a large rotatable cylinder, thereby filling and imparting unidirectional rotational action on the freely supported cylinder(s). The wave volumes and energy of waves discharging onto the weir will at times have sufficient velocity and volume to overshoot the filling of receiving buckets, and as such the potential energy of the excess overshot water could be lost. The invention provides a method whereby the surplus overshot water from the last rotor in any array of possible multiple rotor configurations of this apparatus, is captured in a surge tank and progressively metered into the passing buckets on the downward side of rotor, thereby helping to ensure that all buckets receive maximum possible fill in each rotation.

Accordingly, in one aspect of the invention, the invention comprises an elongated cylinder held in fixed position relative to the elevated weir from which water is discharging:
1 in one embodiment a floating platform is provided to hold the elongated cylinder(s) in an elevated position compatible with the elevation of the overtopping ramp and weir whereby water surges off the crest of the ramp onto/into the weir and directed into the receptor flights on the elongated cylinder(s).
2 a plurality of paddles, buckets, flights or scooped attachment components are mounted on the circumference of the elongated cylinder.
3 said buckets in 2 may be attached in spaced configuration on the circumference of the elongated cylinder, and may also be rotated angularly to create a staggered or helical pattern along the length and circumference of the cylinder; and
4 the cylinder is secured in position on the floating platform, or in a fixed position in the case of a shore mounted location, by sealed journal bearings which are completely isolated from direct sea element exposure. Different bearing types and fixing arrangements may be employed, such as plastic/synthetics in the different sizes, locations and configurations of this invention, and placement thereof.

In one embodiment, the rotating apparatus may be mounted in/on a floating platform wherein the support bearing shaft extensions and bearing assemblies may be enclosed in a separate compartment. Said compartment would be an integrated part of the floating platform, or any suitable support structure, and would be accessible from watertight compartments provided in the hull or enclosure of any suitable support structure.

In one embodiment the output shaft penetrating the sealed bearing compartment is equipped to affix hydrostatic rotary receiving device(s) whereby the action of the rotating cylinder via the support journal(s) imparts rotational motion to the hydrostatic receiver(s) and pumps hydraulic fluid, biodegradable or otherwise, into capture accumulators suitably mounted in secure enclosures in/on the floating platform or other suitable support structure(s) for the rotating cylinder(s).

In a further embodiment to [0011], the hydrostatic rotary receiving devices may include methods for load leveling to mitigate undesirable fluctuations in rotational velocity of the wave capture rotor apparatus. Wave densities could/would vary over a wide range and over varying time periods, on an hour-by-hour and day-by-day basis, and thereby impart more or less potential energy as well as kinetic energy capture to the receiving buckets, affecting the nominal rotational speed of the rotor(s). Our overall systems approach; in addition to the optional overshot water surge tank noted in [0008], will include fluidic coupling apparatus, employed in conjunction with large inertia flywheel(s) to facilitate both nominal speed control of the rotor as well as store kinetic energy and provide stable input torque to the primary hydrostatic rotary receiver(s). Multiple rotors on the same platform may also be linked mechanically or hydrostatically to provide load sharing in optimizing the energy extracted from any wave strength profile presented on the ramp.

This overall load receiving and sharing philosophy provides a complete integrated mechanical power transfer system from wave energy receipt to the terminal hydrostatic receiver(s). Receivers or terminators, in our terminology here, is used to exemplify the depth and detail of our invention and obviate that more than one receiving apparatus may be employed on a single support platform and also may be utilized in many configurations. One option being rotational direction of rotors, which may be either in direction of the receiving waves primary motion, or counter rotational to receiving waves motion. The inclusion of flywheel(s) in the primary drive train provides for an added design adaptation of employing horizontal placement of the large inertia flywheel(s) and the gyroscopic affects to enhance overall stability of the platform.

In one embodiment there is an integral closed loop hydraulic system contained within the floating platform, or other suitable support structure that receives pressurized oil, or other non-compressible bio degradable fluids from the accumulator bank(s) to feed a closed loop hydrostatic control system that delivers a constant volume and pressure output to the primary rotary converter input, to rotate power generators at design speeds and loading.

In another aspect of the invention, the invention comprises, within the floating platform, or other support structure configurations, all necessary power control facilities to synchronize and feed generated power via a sub-surface cable system to land and/or mobile receiving (wireless transmission) electrical grids.

In another aspect of the overall system, the floating platform, or other primary rotating apparatus support configurations, are completely self contained, anchored and/or supported in fixed location via some means, such as sub-surface anchors, slack moorage via heavy anchor chain systems, whereby directional attitude of floating platform may be changed, or support legs, or sub-surface structures. As such the platform, and/or other support configurations is equipped with necessary ballast tankage and pumping facilities to maintain and/or change level of platform relative to the nominal water level and approaching waves. The enclosed platform is equipped with emergency standby power for on-board emergency lighting as well as sump pumps, etc. Feeder cables for all remote control functions and standby power would be included in the sub-surface cable bundle(s) connection to the shore grid.

In another aspect of the overall system, the floating platform may employ SWATH hull design technology to significantly improve stability as well as the transportability of the overall complete system to any suitable location on a world wide basis.

SWATH hull design technology is a sub ocean-surface twin hull support system which carries the load of the primary vessel; floating platform in this case, in the non-turbulent water stream below the ocean surface. In so doing this minimizes the undulating wave force action on the primary vessel on the sea surface, and provides significant dampening of the undulating movement of the hull due to receptive wave action on the wave receiving ramp, thereby maximizing the transfer efficiency of the wave to ramp interface.

In a further aspect of the overall system, the floating platform, in combination with SWATH design, could employ perimeter skirts which would project at various downward angles on the perimeter of the platform to facilitate improved reception of all wave forms approaching the floating platform. These skirts could also provide air capture cavities which could be effectively utilized in changing the ballasting as well as changing the slope and depth attitude of the floating platform. This increased stability and submersability of the floating platform could provide a very significant advantage with respect to dampening the floating platform undulating movement and thereby provide a much more stable and constant position of the wave receiving ramp(s) with minimum interruption to the approaching wave forms. The efficiency of the wave capture and volumetric surge up the ramp and into the wave terminator; the large cylindrical wave capture system, will maximize both potential energy capture as well as facilitate improved kinetic energy capture on initial inrush via the receiving weir and water transfer concept to our overtopping wave capture system.

Another critical aspect of our overall system is that of survivability under extreme ocean wave, and high hurricane wind conditions. Although the floating platform and rugged wave receptor components are designed to operate in high wave and wind conditions on a world wide basis, the system must be suitably protected in the event of extreme abnormal weather conditions (hurricanes and cyclones) that could damage and/or dislodge a stable operating system from its located moorage. The overall system is designed to be completely submersible in the event of severe storm warnings. The submerge command; algorithmic shutdown and submerge command would be provided from a shore weather station base, which could serve as part of the remote shore based control for the overall system under normal operation.

Further system refinements would include remote wireless control of system function on a continuous basis, complete with on-board diagnostic analysis and controls to provide feedback to the base station to facilitate system optimization under all weather conditions.

### BRIEF DESCRIPTION OF DRAWINGS

The invention will now be described by way of exemplary embodiment with reference to the accompanying simplified, diagrammatic, not-to-scale drawings.

In the drawings:

FIG. 1 is one embodiment of an overhead plan view of the apparatus mounted on support platform.

FIG. 2 is a vertical cross-section A-A view of the embodiment from FIG. 1.

FIG. 3 is a vertical cross-section B-B view of another embodiment from FIG. 1.

FIG. 4 is a vertical cross-section view of another embodiment with ramp lead-in profile and receiving ramp profiles.

FIG. 5 is another cross-section view of the embodiment with multiple rotors.

FIG. 6 and FIG. 7 is another overhead plan view of another embodiment showing multiple rotors in two configurations.

FIG. 8 is another overall plan view (overhead view) showing one skirt embodiment of the floating platform.

### DETAILED DESCRIPTION OF THE INVENTION

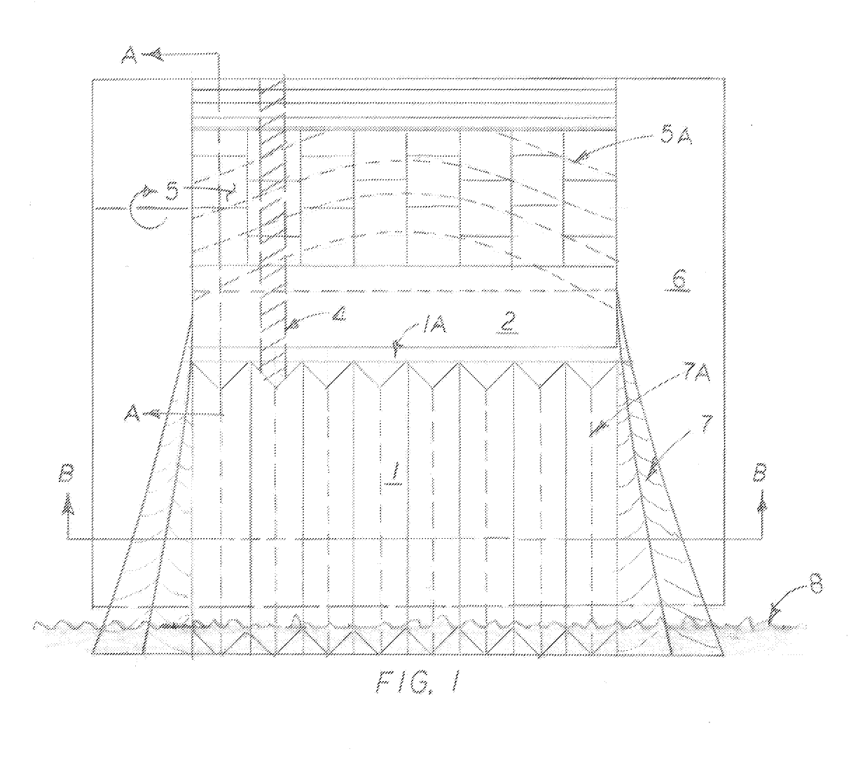

As shown in FIG. 1, the apparatus comprises a support platform 6 which may be designed for flotation or alternatively for securing in a fixed static position, and a wave capture ramp 1 angled up to a waterfall 1A and delivery weir 2. Said weir may be of any length necessary to capture all wave periods, and at the same time, slope down slightly to the center-line of rotor 5, or below depending on the bucket entry configurations on the rotor.

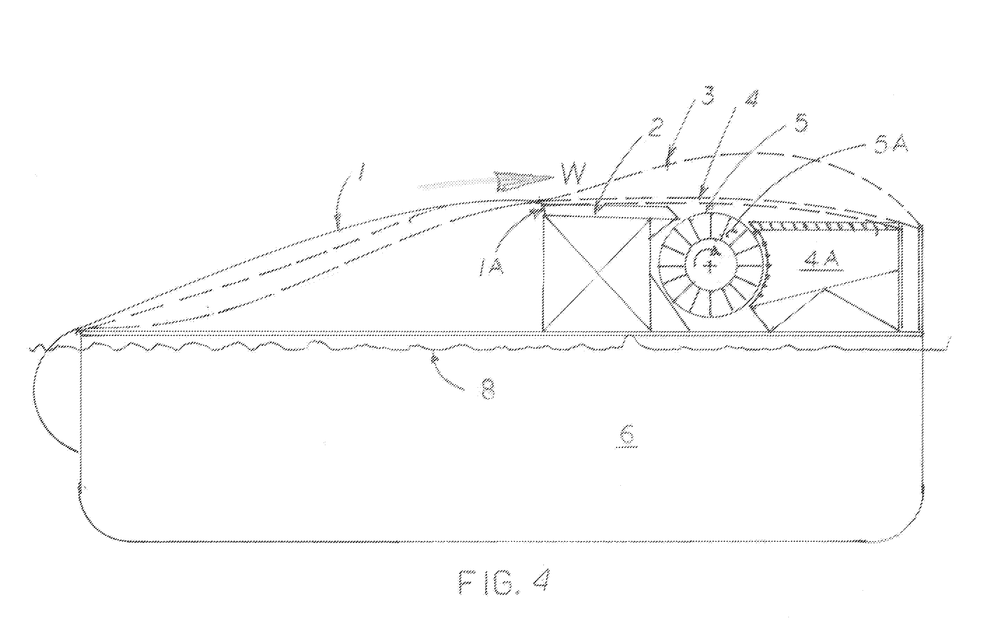

Located above the weir is a trash grate 4 (partial view) which continues over the rotor and down to the support platform beyond the discharge side of the rotor. An over-wash deflector 3 is attached to the trash grate, shown in FIG. 3 and may be employed at various slopes to both dissipate voluminous waves as well as assisting in excluding large debris from the trash grate 4. One angular spaced arrangement of receptor flights/buckets is shown by the curves 5A, rotor 5.

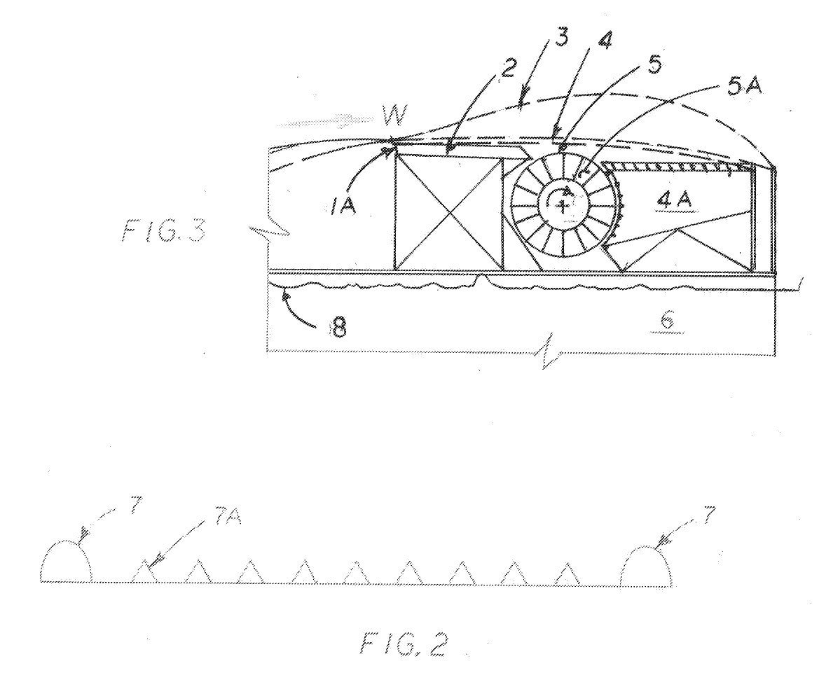

FIG. 2 shows a simplified cross-section B-B of ramp 1 embodiment showing alignment ribs 7A and the wave converging tenders 7 on both sides of the ramp.

FIG. 3 shows sectional embodiment A-A from FIG. 1 indicating partial ramp and wave direction W, the waterfall 1A, weir 2, over-wash deflector 3 and trash grate 4.

The rotor 5 is also shown indicating pockets 5A in/near/on the perimeter of the rotor. Pockets/flights 5A may be of any geometric shape that will capture, retain, and release water efficiently. However, and noted specifically here, the last rotor on any multiple rotor assembly, will have all pockets configured in a forward sloping configuration; that is the approach or receiving slope on the buckets is in the opposite direction to that of the rotor rotation. Pockets/flights may also have affixed to, or in the receiving chambers, bars and/or perforations of various sizes and shapes to optimize receipt and retention of the water flow splashing into the buckets and control thereof. These added fixtures to the primary bucket assemblies may be attached at various different angles to that of the buckets as a whole. Pockets/flights and attachments may also be composed and/or formed of synthetic materials to reduce weight and improve strength.

FIG. 4 shows another cross-section/elevation of ramp 1, wave direction W, indicated by heavy arrow, and various ramp profiles indicated by broken lines. Note that these ramp profiles are for illustrative purposes only, and each overall integrated platform assembly 6 could exhibit customized platform ramp profiles and water access portals to feed multiple rotors, in some cases, depending on various designs and final arrangements. Also shown for further clarity is waterfall 1A, weir 2, overwash assembly 3, grate 4, rotor 5, and water capture bucket 5A along with overshot water surge tank 4A. Nominal water level 8 is also shown for reference.

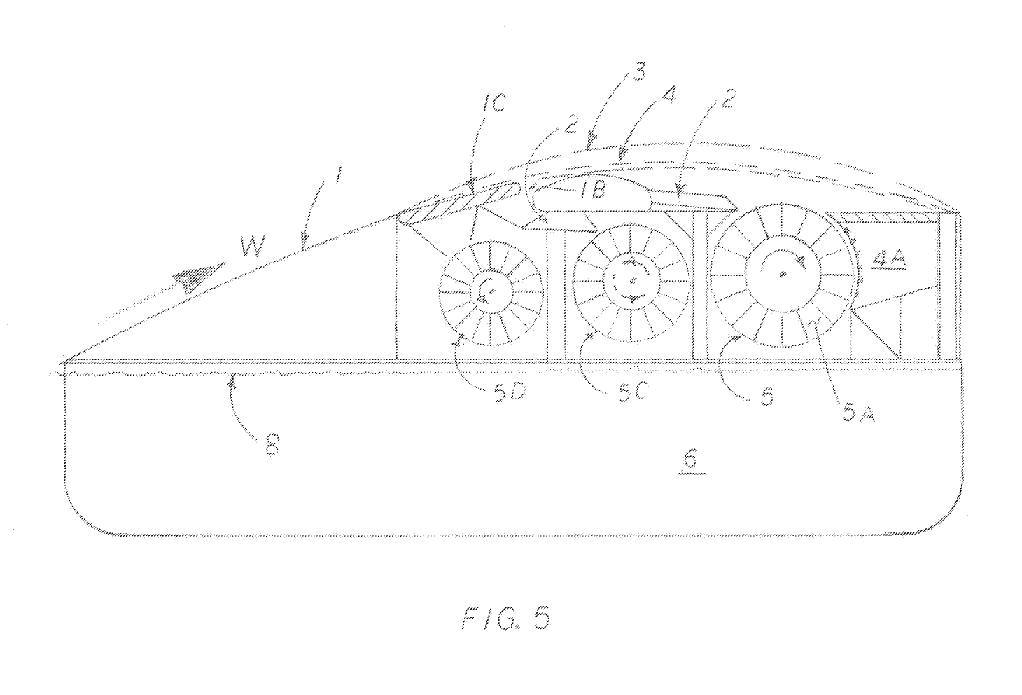

FIG. 5 is another cross-section/elevation embodiment on platform 6 of the invention, showing wave direction W on ramp 1 whereby a metering slot 1B is employed to feed a secondary rotor 5C. Also shown is a tertiary rotor 5D whereby all wave energy levels may be captured and help optimize the overall wave energy recovery process. The low wave energy recovery grid 1C is located lower on the receiving ramp 1 to optimize recovery of all wave energies presented. It should be noted here also that various ramp configurations; length, slope and elevations may be employed, particularly in larger apparatus to encompass more than three rotors in total. It should be noted that the lead rotor(s), in the direction of water receipt on the ramp, may rotate in a counter rotation to the nominal flow of water up the ramp. This embodiment allows the secondary 5C and tertiary 5D rotors in this example to be linked via an appropriate drive linking system to maximize energy recovery and in so doing provide load leveling output between these two rotors.

An added inventive concept here is that the wave energy recovery grid 1C has a metering capability to feed both rotors 5C and 5D simultaneously, again for a load balancing effect. Another embodiment could include multiple rotors of various lengths; that of being offset in a staggered pattern across the width of the receiving ramp with separate or combinations of metering slots and weirs to feed water to multiple rotors mounted on a large common platform.

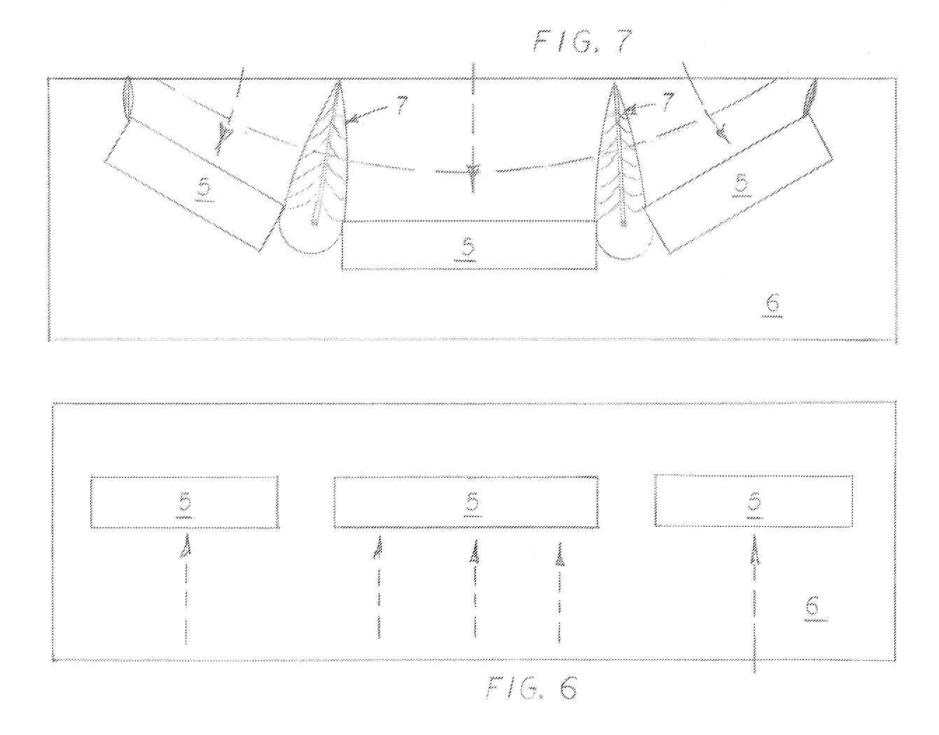

FIG. 6 and FIG. 7 are embodiment whereby multiple rotors 5 are mounted on a support platform(s) 6 and whereby three dimensional curved buttresses 7 may be used to direct wave energy efficiently to the rotor groups.

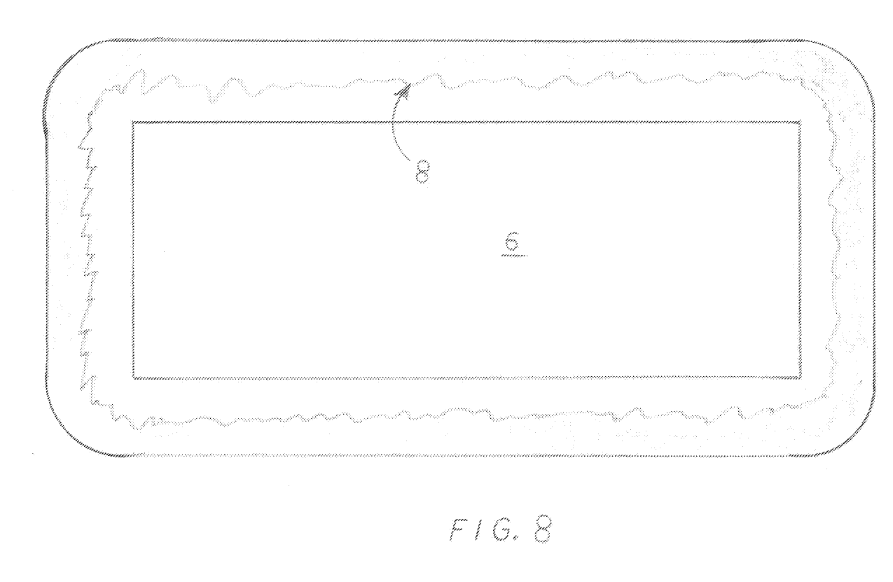

FIG. 8 is a conceptual overhead view of a floating platform 6 showing nominal water level 8. The focus here is to look at the impetus to maximize the stability of any floating platform under the severest ocean weather conditions, and also in combination with a SWATH equipped floating platform configuration. Under the submerge command prompted by extreme weather conditions, this complete assembly would not be visible, other than by mandatory standard navigational lighting that would extend suitably above the water line and obviate the location and size of the submerged vessel.

What is claimed:

1. A rotatable elevated cylindrical apparatus which may be secured in/on a floatable and transportable platform fitted with progressively elevating ramp(s) to receive, direct and raise waves to a suitable level whereby the in-rushing water is directed into collector buckets on the perimeter of a rotatable elevated receiving apparatus and thereby providing the kinetic energy and potential recoverable energy necessary to turn the freely supported rotatable apparatus at a rotational speed commensurate with the period of wave receipts, for the purpose of converting the wave energy such received into electrical energy which may be transported to a shore grid via subsurface cable or other means.

2. A power generating system of claim 1 wherein the progressively elevating ramp configurations may be configured such that there may be various geometric profiles, both positive and negative curves or other irregularities with respect to a straight line elevating profile from nominal water level to level required to feed the rotatable apparatus of claim 1, to facilitate and optimize capture of a variety of wave period which could be experienced on a world wide application basis for this unique invention.

3. A power generating system of claim 1 wherein there may be multiple rotor apparatus employed and fixed in staggered configuration across the width of the receiving ramp(s) and fixed at different vertical elevations relative to the nominal water level receipts up the ramps.

4. An adaptation of the ramp configurations of claim 2 wherein converging and raised side fenders are provided on each side of the ramp to intercept the widest swath of waves approaching the floating platform of claim 1 and thereby funnel the maximum amount of water being directed to the rotary receiving device of claim 1.

5. An adaptation to claim 4 wherein corrugation profiles of various amplitude may be incorporated in the surface of the ramp(s) in the direction of water flow to assist in presenting the waves water flow more uniformly up the ramp of claim 2 and hence better distribution to the rotatable apparatus of claim.

6. A power generating system of claim 1 wherein the elevating ramp(s) terminates via a waterfall profile or drop into a water receiving flume or weir the full width of the rotating apparatus to uniformly distribute water flow onto the rotating apparatus and into the receiving buckets.

7. An adaptation and addition to claim 6 wherein a trash or debris grate/screen is incorporated on top of the receiving flume and continues over the full width of the cylindrical rotating apparatus in claim 1 to discharge water borne debris and/or other materials and sea inhabited species which may be captured via the flushing of water up the receiving ramp of claim 2.

8. A power generating system of claim 1 wherein the support journal shafts and bearing assemblies and all fixtures to couple the rotating action of the primary receiver of claim 1 and the converting hydraulic apparatus is enclosed in watertight compartments as an integral or extended part of the floating platform.

9. A power generating system of claim 1 wherein the floating support platform incorporates a SWATH hull design configuration to enhance the stability of the floating platform in normal position and use; as well as ensure the smooth transportability of the overall assembly to various active world sites where the complete integrated operational system may be deployed.

10. A power generating system of claim 1 wherein large inertial flywheels are incorporated within the hull design to serve the primary function of load leveling for the overall hydrostatic system, and secondarily to provide added stability to the floating platform by mounting the flywheels in a horizontal position and thereby enhance stability by the gyroscopic effect of one or more flywheels which may be incorporated in the platform design.

11. A power generating system of claim 1 wherein the floating support platform and all normal above water systems are designed to operate under the most rugged operational conditions that may be experienced in high energy wave sites around the world, and an additional safeguard, in the event of a 100 year storm, wherein the floating platform can be completely submerged via remote control from a land based or remote wireless system, and remain dormant until a restore operation command is transmitted to again surface and commence continuous operation.
